(19) United States
(12) Patent Application Publication
(10) Pub. No.: US 2025/0351782 A1
(43) Pub. Date: Nov. 20, 2025

(54) ENERGY AND HYDROMETRIC CONTROL OF HORTICULTURAL GREENHOUSES

(71) Applicant: Les Industries Harnois Inc., Saint-Thomas (CA)

(72) Inventors: Patrice HARNOIS, Saint-Élisabeth (CA); Yves DUBÉ, Lourdes-de-Jollette (CA)

(73) Assignee: Les Industries Harnois Inc., Saint-Thomas (CA)

(21) Appl. No.: 19/285,573

(22) Filed: Jul. 30, 2025

Related U.S. Application Data
(63) Continuation of application No. PCT/CA2024/050128, filed on Feb. 2, 2024.

(30) Foreign Application Priority Data
Feb. 2, 2023 (FR) 2300960
Mar. 24, 2023 (FR) 2302817

(51) Int. Cl. A01G 9/24; A01G 9/26; F24H 4/04; F24H 15/355

(52) U.S. Cl. CPC A01G 9/245; A01G 9/243; A01G 9/247; A01G 9/26; F24H 4/04; F24H 15/355

(57) ABSTRACT

The invention concerns a system and method for energy and hydrometric control of a horticultural greenhouse. The present invention proposes a perfect and complementary arrangement of various energy sources while optimizing them. The use of fossil energy is significantly reduced, making it possible to achieve carbon neutrality, whatever the season and/or climate, and external CO₂ becomes a usable and manageable source of fertilizer. In particular, the invention optimizes the use of heat pumps and other energy sources, preferably alternative energy sources such as hydraulic, wind, solar, geothermal, biofuel or a mixture of these.

### CROSS-REFERENCE TO RELATED APPLICATIONS

This patent application is a continuation of PCT/CA2024/050128 filed on Feb. 2, 2024, which claims the priority of French patent applications no. FR 2 300 960 filed on Feb. 2, 2023, and no. FR 2 302 817 filed on Mar. 24, 2023, the contents of which are incorporated herein by reference.

### FIELD OF THE INVENTION

The present invention relates to a system for controlling energy and/or hydrometry in the greenhouse field, in particular for horticultural greenhouses for vegetable production.

### TECHNOLOGICAL BACKGROUND TO THE INVENTION

Climate change, the average rise in temperatures and the adverse effects it causes are now known and recognized by a vast majority of civilians and acknowledged by the scientific community. It is recognized that rising temperatures are accompanied by extreme heat spikes. It is recognized that the additional energy accumulated in our atmosphere is pumping much more moisture into our oceans and lakes, and that this moisture is occasionally transformed into violent phenomena, but generally speaking, humidity levels are on the rise in many parts of the globe. It is recognized that climate change is largely linked to human activities and our propensity to use fossil fuels, which are the main source of GHG emissions, notably carbon dioxide (CO₂).

It is also recognized that agricultural activities are closely linked to the climate. Any change brings new challenges and sometimes insurmountable constraints. It goes without saying that open-field farming is the hardest hit by these changes. However, protected production (greenhouses or other) is also affected, and current climate trends mean that new technologies will be required. Rising outside temperatures have a direct impact on the inside temperature of greenhouses. Rising outdoor humidity levels also have a direct effect on the climate inside the greenhouse, and on plant production levels. Too high a humidity level can prevent plants from breathing, reduce the efficiency of photosynthesis and encourage the development of diseases, fungi, etc.

Since CO₂ is an essential element for plants, it is recognized that the only (probable) positive point of climate change is the increase in CO₂ concentration, which favors faster plant growth. But how can we take advantage of this, and how can we consume more than we generate? Paradoxically, it is recognized that a greenhouse regularly needs a heating system to maintain the temperature at an optimum level and avoid dew point. In today's context, heating is often associated with the consumption of fossil fuels, and therefore of CO₂. The present invention tackles this problem by minimizing the input of fossil energy.

For over 50 years, greenhouse growers have been using simple, natural means of ventilation, in different forms, with different types of opening and different mechanisms. In the current and future context, traditional greenhouses with natural ventilation will rapidly reach their limit and become less and less efficient.

Greenhouse manufacturers and the growers who use them therefore face a major challenge. How to produce fruit and vegetables on a continuous basis in a context of obvious climate change. How to produce efficiently, how to contribute to slowing the rise in temperatures, how to reduce the carbon footprint, how to reduce the use of fossil fuels, how to design greenhouses offering the climate required by plants. Relevant questions calling for action, solutions and leading to the invention here.

Since refrigeration (internal temperature control) by natural means is less and less appropriate or insufficient, we have to turn to mechanized means. Mechanized means equals energy, equals increased CO₂, and certainly increased production costs. The challenge is therefore to reinvent the typical greenhouse, and its components, in order to achieve the best growth environment without adding to the climate problems already underway.

The first element to consider is the internal clearance height of greenhouses. Naturally, the ambient air will rise as it gains in temperature. Some surplus energy accumulates at the greenhouse ridge and can be managed there. A ridge height of 9 m will provide a gradient of 10° C. between the ground and the greenhouse ridge. Increased height and volume should be considered when designing a modern greenhouse.

As temperatures rise (inside and outside), it's very likely that we will reach a point where the enthalpy (internal energy) of the outside air is greater than the enthalpy of the inside air. At this point, the natural cooling mechanisms no longer work, and it's definitely time to switch to mechanized means. Conventional cooling systems consist of misters or evaporator panels located on a greenhouse wall or in a mixing chamber. Air passing through these panels drops in temperature, but its relative humidity rises sharply. In a context where outside air is increasingly hot and humid, this kind of purely adiabatic system rapidly becomes inoperative. The first alternative to direct adiabatic cooling is the use of refrigeration units. Although functional when properly designed, these units consume a lot of energy.

A second alternative is the use of heat pumps, with or without energy storage. This is an interesting solution, but in its current form and use, it is incomplete and makes little contribution to lowering CO₂ levels. Furthermore, heat pumps can still be energy-hungry if they are used incorrectly, or if heat pump operating parameters are not optimized.

### OBJECT OF THE INVENTION

The present invention provides a solution to the above-mentioned problems. The invention relates to a system and method for energy and hydrometric control of a horticultural greenhouse.

The present invention proposes a perfect and complementary arrangement of the various energy sources while optimizing them. The use of fossil energy is significantly reduced, making it possible to achieve carbon neutrality, whatever the season and/or climate, and external CO₂ becomes a usable and manageable source of fertilizer. In fact, the invention optimizes the use of heat pumps and other energy sources.

The greenhouse can be cooled in 2 phases. The first cooling phase is a mechanical refrigeration phase, while the optional second phase is adiabatic cooling via misters. Adiabatic cooling is known to be energy-efficient but limited. When supported by a mechanized source, the overall process becomes highly efficient. It should be noted that the misters are located within the greenhouse enclosure, so the whole greenhouse becomes like one big mixing chamber where every change in air phase or characteristics takes place at the right place.

The present invention makes it possible to drastically reduce the need for fossil fuels, without however banishing them. The invention is based more on resource optimization, management and energy transfers between batteries, which are carried out at low cost and according to night and day cycles.

The process according to the invention is intended to be implemented by a computer, via a computer program consisting of instructions adapted to implement at least each of the steps of this process.

### BRIEF DESCRIPTION OF THE INVENTION

According to a first aspect, the invention relates to an energy and hydrometric control system for a horticultural greenhouse, characterized in that it comprises:
a set of heating pipes installed in the greenhouse to heat the greenhouse interior;
a set of radiators installed in the greenhouse to heat or cool the greenhouse interior; one or more boilers;
one or more electrically powered heat pumps;
a first tank configured to contain a first fluid previously heated to a first temperature Te of between about 45 and 90° C. using:
   said one or more boilers;
   heat exchange with a distribution loop of a second fluid pre-heated to a second temperature by means of said one or more electrically powered heat pumps programmed to produce heat; or
   the combined action of the one or more boilers and the heat exchange with the distribution loop;
the distribution loop forming part of the control system, and the first tank being fluidly connected to the set of heating pipes installed in the greenhouse to heat the greenhouse interior;
another reservoir configured to contain a third fluid previously cooled to a temperature of between about 2 and 10° C. using the electrically powered heat pump(s) programmed to produce cold;
the distribution loop and the other reservoir being fluidly connected to the set of radiators installed in the greenhouse to heat or cool the interior of the greenhouse; and
a hydrological station comprising at least one first probe for measuring the temperature inside the greenhouse, at least one second probe for measuring the temperature outside the greenhouse and at least one probe for measuring the humidity level inside the greenhouse.

According to this first aspect, the invention also concerns a method of energy and hydrometric control of a horticultural greenhouse implementing the system as described above, comprising the following steps:
a) the outside temperature of the greenhouse (Tₑₓₜ₎ is measured;
b) i) when the measured outside temperature Tₑₓₜ is below a threshold temperature (for example: T₍ₑₓₜ₎≤10° C.), the inside of the greenhouse is heated via the heating pipes supplied by the first fluid;
   ii) when the measured outside temperature Tₑₓₜ is above the threshold temperature (e.g. Tₑₓₜ>10° C.), the inside of the greenhouse is heated via the radiator assembly supplied by the second fluid; or
   iii) when the outside temperature Tₑₓₜ measured is equal to or greater than a useful temperature of the greenhouse, the inside of the greenhouse is cooled by means of said set of radiators supplied by the third fluid.

According to other advantageous and non-limiting features of the invention according to this first aspect, taken alone or in any technically feasible combination:

The system is characterized in that the distribution loop is configured to heat the second fluid to temperature Te when the temperature outside the greenhouse is high enough to use only the heat pump(s) to heat the first fluid in the first tank and the second fluid in the distribution loop.

The system is characterized in that it further comprises a second reservoir designed to contain the second fluid previously heated using the heat pump(s), said heat exchange then taking place between the first and second reservoirs, the second reservoir being fluidly connected to the set of radiators installed in the greenhouse to heat the greenhouse interior.

According to a second aspect, the invention relates to an energy and hydrometric control system for a horticultural greenhouse, comprising:
a set of heating pipes installed in the greenhouse to heat the greenhouse interior;
a set of radiators installed in the greenhouse to heat or cool the greenhouse interior;
one or more boilers;
one or more electrically powered heat pumps;
a first high-temperature energy stack comprising a first reservoir configured to contain a first volume of a first fluid previously heated to a first temperature of at least 60° C. using the one or more boilers, the first stack being fluidly connected to a set of said heating pipes installed in the greenhouse to heat the interior of the greenhouse;
a second medium-temperature energy stack comprising a second reservoir configured to contain a second volume of a second fluid previously heated to a second temperature of between approximately 40 and 60° C. using the one or more electrically powered heat pumps programmed to produce heat, the second stack being fluidly connected to said set of radiators installed in the greenhouse to heat the interior of the greenhouse;
a third low-temperature energy stack comprising a third reservoir designed to contain a third volume of said second fluid previously cooled to a third temperature of between about 2 and 10° C. using the electrically powered heat pump(s) programmed to produce cold, the third stack being fluidly connected to said set of radiators installed in the greenhouse to cool the interior of the greenhouse; and
a hydrological station comprising at least one first probe for measuring the temperature inside the greenhouse, at least one second probe for measuring the temperature outside the greenhouse and at least one probe for measuring the humidity level inside the greenhouse;
   and wherein:
the first and second energy stacks are thermally interconnected to enable heat exchange from the first to the second stack when the outside temperature is too low to use the heat pump(s) to heat the second fluid in the second energy stack.

The invention also concerns a method of energy and hydrometric control of a horticultural greenhouse implementing the system as described above, characterized in that it comprises the following steps:
a) the outside temperature of the greenhouse (Tₑₓₜ) is measured;
b) i) when the measured outside temperature Tₑₓₜ is below a minimum threshold for heat pump operation (for example: T₍ₑₓₜ₎≤10° C.), the inside of the greenhouse is heated via the heating pipes supplied by the first high-temperature energy stack;
   ii) when the measured outdoor temperature Tₑₓₜ is within an optimum operating range for the heat pumps (e.g. between −10° C. and +10° C.), the interior of the greenhouse is heated via the radiator assembly fed by the second, medium-temperature energy stack; or
   iii) when the measured outside temperature is equal to or greater than a useful temperature of the greenhouse, the inside of the greenhouse is cooled by means of said
   set of radiators powered by the third low-temperature energy stack; and the method also being characterized in that, when the outside temperature approaches the minimum heat pump operating threshold, the method comprises:
c) a step in which heat is exchanged from the first energy stack to the second energy stack to heat the second fluid in the second energy stack.

The invention also relates to a computer program comprising instructions suitable for implementing each of the steps of the methods described above, when the program is run on a computer.

According to other advantageous and non-limiting features of the invention according to the first or second aspect thereof, taken alone or in any technically feasible combination:
the system is characterized in that it further comprises mechanized and controllable means for admitting air from outside the greenhouse to inject air at greenhouse floor level, at greenhouse ridge level, or at both levels in order to control greenhouse hydrometry.

The system is characterized in that the first fluid comprises water and the second fluid comprises a high efficiency energy transport fluid such as glycol, oil or steam.

The system is characterized in that the first stack is also fluidly connected to a set of means, such as pipes, installed outside the greenhouse for melting ice and/or snow present in the vicinity of the greenhouse.

The system is characterized in that:
the boiler or boilers are powered by fossil, electric or geothermal energy, or a mixture of these energies; and
the heat pump(s) are supplied with electricity generated by alternative energies such as hydraulic, wind, solar, geothermal, biofuel, or a mixture of these energies.

The system is characterized in that it further comprises adiabatic and controllable greenhouse cooling means installed in the greenhouse, such as misters, in order to control the hydrometry of the greenhouse.

The system is characterized in that the operation of the hydrological station and its probes, the boiler(s), the thermal pump(s), the mechanized and controllable means of fresh air supply, and/or the heat transfer is programmable and controllable by a computer or an intelligent device equipped with computer software and connected to the various control elements of the greenhouse via a wired or wireless network such as WiFi or Bluetooth™.

The method is characterized in that it further comprises a step in which air from outside the greenhouse is injected at greenhouse floor level, at greenhouse ridge level, or at both levels in order to control greenhouse hydrometry.

### BRIEF DESCRIPTION OF THE FIGURES

Further features and advantages of the invention will become apparent from the detailed description of the invention which follows with reference to the appended figures, on which:

FIG. 1 shows a first general diagram illustrating preferred modes of the invention;

FIG. 2 shows a diagram of a greenhouse in front view, illustrating preferential modes of the invention;

FIG. 3 shows a diagram of a greenhouse seen from the side, illustrating preferred modes of the invention; and

FIG. 4 shows a second general diagram illustrating preferred modes of the invention.

### DETAILED DESCRIPTION OF THE INVENTION

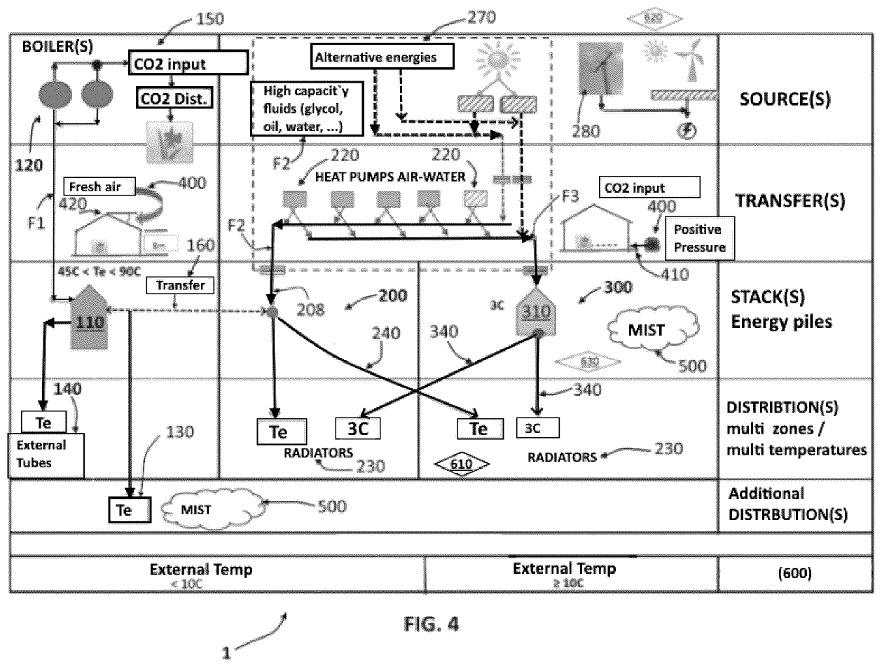

According to a first aspect, the present invention relates to a system (1) for energy and hydrometric control of a horticultural greenhouse, as illustrated in FIG. 4. Preferably, this system is suitable for use in greenhouses in temperate or warm climate regions.

The system (1) comprises a first reservoir (110) designed to contain a first fluid (F1) previously heated to a first temperature Te of between about 45 and 90° C. The first fluid (F1) is heated either by one or more boilers (120), preferably the boiler or boilers (120) are powered by fossil fuels, such as gas, electricity, biomass energy, geothermal energy, or a mixture of these; or by heat exchange (160) with a distribution loop (208) of a second fluid (F2) previously heated to a second temperature by one or more electrically-powered heat pumps (220) programmed to produce heat. The fluid (F1) can also be heated by the combined action of the boiler(s) (120) and the heat exchange (160) with the distribution loop (208). The first reservoir (110) is fluidly connected to a set of heating pipes (130) installed in the greenhouse to heat its interior. For example, water at around 60° C. is circulated through the heating pipes (130). The system (1) also includes a further reservoir (310) designed to contain a third fluid (F3) previously cooled to a temperature of between about 2 and 10° C. using the electrically powered heat pump(s) programmed to produce cold. The distribution loop (208) and the other reservoir (310) are fluidly connected to a set of radiators installed in the greenhouse to heat or cool the greenhouse interior.

According to this first aspect, the invention also relates to a method of energy and hydrometric control of a horticultural greenhouse implementing the system (1) as described above. The method is characterized in that it comprises the following steps:
a) the outside temperature of the greenhouse (Tₑₓₜ) is measured;
b) i) when the measured outside temperature Tₑₓₜis below a threshold temperature (for example: T₍ₑₓₜ₎≤10° C.), the inside of the greenhouse is heated via heating pipes supplied with the first fluid;
   ii) when the measured outside temperature Tₑₓₜis above the threshold temperature (e.g. Tₑₓₜ>10° C.), the inside of the greenhouse is heated via the radiator assembly fed by the second fluid; or
   iii) when the outside temperature Tₑₓₜmeasured is equal to or greater than a useful temperature of the greenhouse, the inside of the greenhouse is cooled using said set of radiators (230) supplied by the third fluid (F3).

According to a preferred mode, the system (1) is characterized in that the distribution loop (208) is configured to heat the second fluid (F2) to the second temperature at temperature Te when the temperature outside the greenhouse is high enough to use only the heat pump(s) to heat the first fluid in the first tank and the second fluid in the distribution loop.

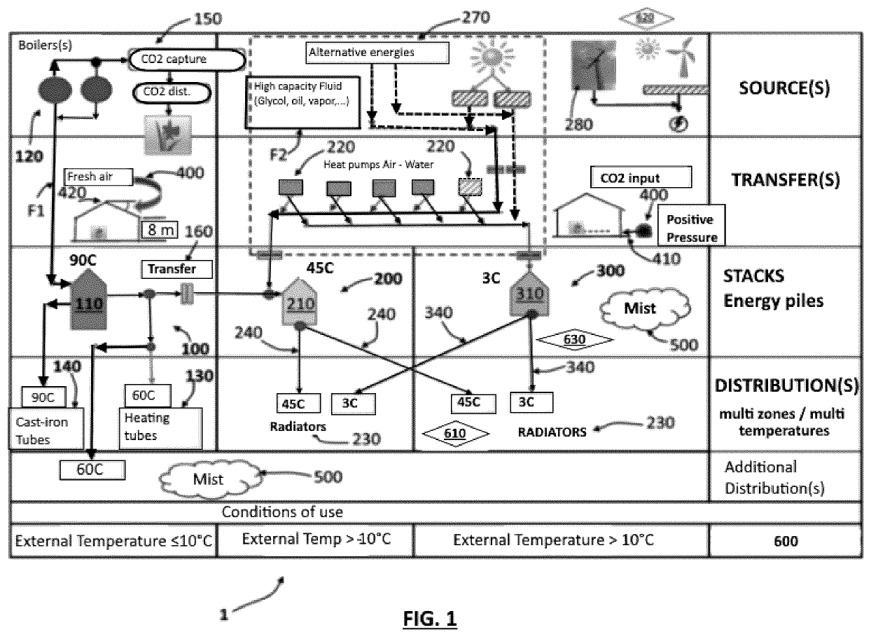

According to a preferred mode, the system (1) can further comprise a second tank (210) designed to contain the second fluid previously heated using the heat pump(s) (220), said heat exchange then taking place between the first and second tanks. This preferred mode will be described in greater detail in the following description of the second aspect of the invention, illustrated in particular in FIG. 1.

This first aspect of the invention has the following features.
It is primarily suited to regions with minimal heating demand (including, but not limited to, the southern USA or countries such as Mexico).
The cold source comes from the distribution loop, preferably with glycol as a second fluid, which is coupled to heat pumps or other cooling sources. In some hot climates, glycol may be replaced by water.
The heat source comes from the boiler and/or the distribution loop (e.g. glycol). Again, in some hot climates, glycol may be replaced by water.
What's more, in some cases, the boiler will not be required, or only for safety purposes or to generate CO₍₂₎ (see details below).
The hot water distribution loops can all operate within a normal range, i.e. between approx. 45° C. and 90° C., without restriction and independently of each other.
The energy link between the distribution loop and the first reservoir is bidirectional, but not constrained.
The ranges of use of the various systems are modified and are more random, since in hot regions the need for dehumidification can take precedence over everything else.

According to a second aspect, the present invention concerns a system (1) for energy and hydrometric control of a horticultural greenhouse, as illustrated in FIG. 1. This second aspect of the system according to the present invention can be used in any climate, in particular colder temperate, continental or northern climates.

The system (1) comprises a first high-temperature energy stack (100) comprising a first reservoir (110) designed to contain a first volume (e.g. 3000 m³) of a first fluid (F1), such as water, previously heated to a first temperature of at least 60° C., preferably between 6° and 90° C. The first fluid (e.g. water) is heated by one or more boilers (120). Preferably, the boiler or boilers (120) are powered by fossil fuels, such as gas, electricity, biomass energy, geothermal energy, or a mixture of these. The first battery (100), in particular its reservoir (110), is fluidly connected to a set of heating pipes (130) installed in the greenhouse to heat its interior. For example, water at around 60° C. circulates through the heating pipes (130). According to a preferred mode, the first stack (100) is also fluidly connected to a set of means, such as pipes (140), designed to be installed outside the greenhouse to melt ice and/or snow present in its vicinity. For example, water at around 90° C. circulates through the pipes (140). The pipes (140) can be made of cast iron, steel (with or without fins), or any other suitable heat-conducting material.

As illustrated in FIG. 1 or 4, the carbon dioxide—CO₂—(150) produced by the combustion of fossil energy in the boilers (120) can be captured and reused, at least in part and depending on its quality, to feed the greenhouse plants which will absorb this CO₂, thus reducing the production of greenhouse gases (GHG).

The system (1) also includes a second medium-temperature energy stack (200) comprising a second reservoir (210) designed to contain a second volume (e.g. 2000 m³) of a second fluid (F2) previously heated to a second temperature of between about 40 and 60° C., preferably about 45° C. Preferably, the second fluid (F2) comprises a high-efficiency energy-transport fluid, such as glycol, oil or steam.

The second fluid (F2) feeding the second stack (200) is heated by one or more electrically operated heat pumps (220) programmed to produce heat. A heat pump (HP) is a device for transferring thermal energy from a low-temperature medium (cold source) to a high-temperature medium (hot source). This device therefore reverses the natural direction of spontaneous thermal energy transfer. Depending on the operating direction of the pumping device, a heat pump can be considered as a heating system, if the temperature of the hot source is to be raised, or as a refrigeration system, if the temperature of the cold source is to be lowered. For cold production, the process is the basis of virtually all air conditioners and refrigerators. For heat production, the process differs from conventional heating, in which a body is heated (by Joule effect, by combustion, or by any other process).

Preferably, the heat pumps used are of the air-to-water or water-to-water type.

According to a preferred mode of the invention, the useful number of heat pumps will be determined as a function of various structural parameters, such as greenhouse volume, and climate. In addition, the heat pumps (220) can preferably be supplied with electricity generated by alternative energies (270) such as hydraulic, wind, solar, geothermal, biofuel, biomass or a mixture of these energies. Here again, the use of non-fossil energy is made possible by the fact that the amount of electricity required to operate the heat pumps and heat the second fluid to between approximately 40 and 60° C. is less than the amount of energy required to power the boilers (120) feeding the first stack and produce a first fluid at high temperature.

The second stack and its reservoir (210) are fluidically connected via a first fluidic network (240) to a set of radiators (230) installed in the greenhouse to heat its interior.

Preferably, the hot cell reservoirs (110, 210) are installed outside the greenhouse or greenhouses. In fact, the hot batteries can be designed to supply heat to one or more greenhouses.

The system (1) also includes a third low-temperature energy stack (300) comprising a third tank (310) designed to contain a third volume (e. 500 m³) of said second fluid (F2) previously cooled to a third temperature of between about 2 and 10° C. using the heat pump(s) described above. In this case, the pumps are programmed to produce cold. The third stack and its reservoir (310) are fluidically connected to the same radiators described above, via a second fluidic network (340), both to cool or control the greenhouse temperature, but also to dehumidify the greenhouse.

According to the present invention, the first and second energy stacks (200, 300) are thermally interconnected to enable heat exchange or transfer (160) from the first to the second stack, and this when the outside temperature is too low to use the heat pump(s) (220) to heat the second fluid (F2) of the second energy stack (200). This represents an advantage of the present invention, particularly in regions of the world, such as Canada or northern Europe, where winter temperatures can fall well below −10° C. In a preferred mode, this heat transfer can be achieved with a heat exchanger, for example with a power of 2 MW.

In a preferred mode, heat can be transferred from the low-temperature stack (300) to the medium-temperature stack (200) at the same time as the diurnal and nocturnal cycles, to maintain the temperature of the second fluid in the medium-temperature stack using the heat extracted from the cold stack (300). For example, a water-to-water heat pump can be used. A water-to-water heat pump enables energy to be transferred between the 3° C. and 45° C. stacks, at a very low energy level.

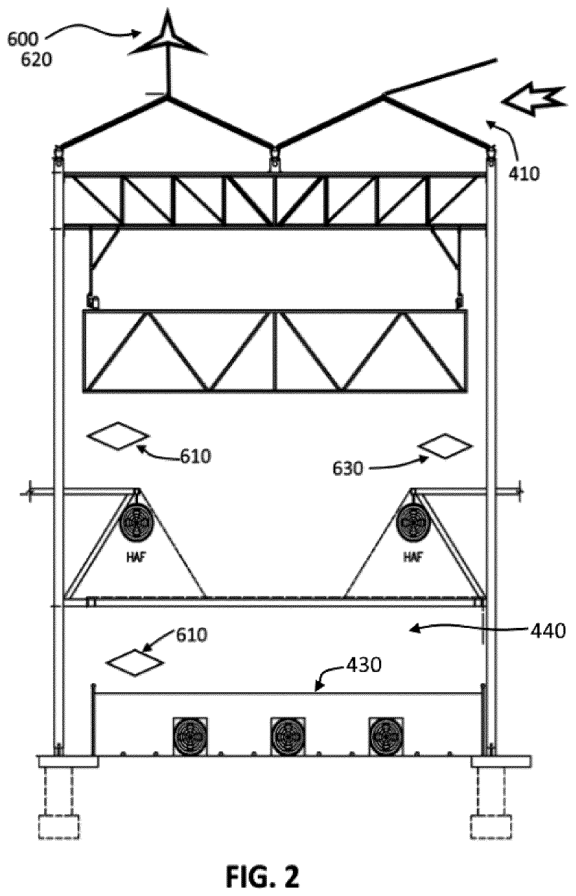

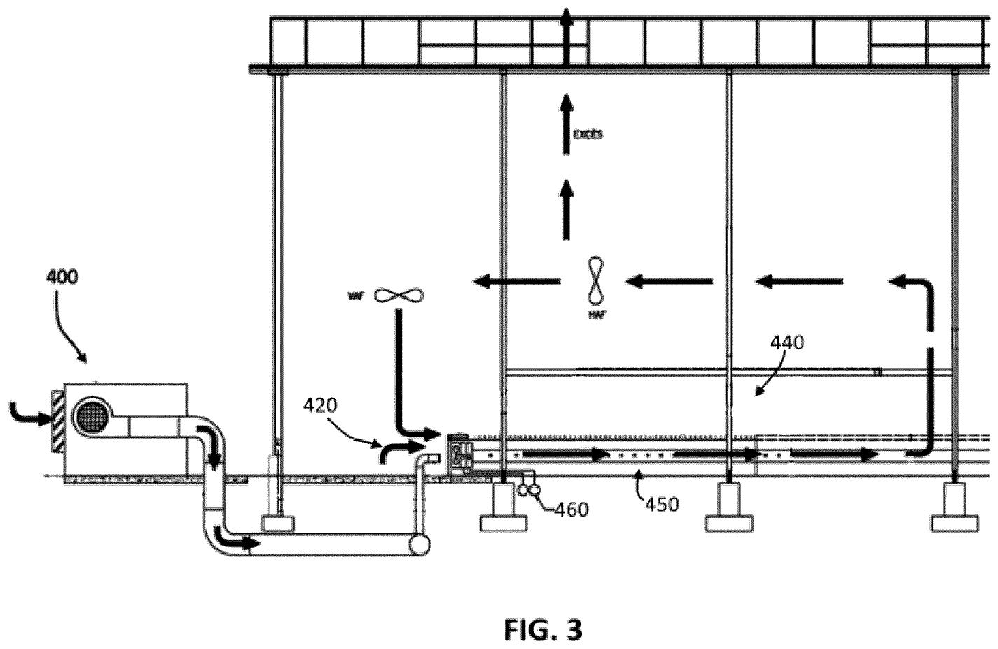

The system (1) also includes mechanized and controllable means for supplying fresh air (400) from outside the greenhouse to inject air at greenhouse floor level (410), at greenhouse ridge level (420), or at both levels in order to control greenhouse hydrometry. These means will be described in greater detail below with reference to FIGS. 2 and 3.

According to a preferred mode of the invention, the system (1) also comprises adiabatic and controllable greenhouse cooling means (500) installed in the greenhouse, such as misters, in order to control the hydrometry of the greenhouse. Again, these means will be described in greater detail below with reference to FIGS. 2 and 3.

According to a preferred mode of the invention illustrated in FIG. 1, the system (1) also comprises a hydrological station (600) comprising at least one first temperature measurement probe (610) inside the greenhouse, at least one second temperature measurement probe (620) outside the greenhouse and at least one humidity measurement probe inside the greenhouse (630).

According to a preferred mode of the invention, the operation of the hydrological station (600) and its probes, of the boiler(s) (120), of the thermal pump(s) (220), of the mechanized and controllable fresh air supply means (400), and/or the heat transfer (160) between the first and second energy stacks is programmable and controllable by a computer or intelligent device equipped with computer software and connected to the various greenhouse control elements via a wired or wireless network such as WiFi or Bluetooth™.

According to the second aspect, the present invention also relates to a method of energy and hydrometric control of a horticultural greenhouse, implementing the system as described in the present application and in which the set points must be adapted to the climates and technologies used without limiting them. The method comprises the following steps:
a) the outside temperature Tₑₓₜ of the greenhouse is measured, for example with the outside sensor (620);
b) i) when the measured outdoor temperature Tₑₓₜ is below a minimum threshold for heat pump operation (e.g. T₍ₑₓₜ₎≤10° C.), the inside of the greenhouse is heated via the heating pipes supplied by the first high-temperature energy stack;
   ii) when the outside temperature Tₑₓₜ measured is within an optimum operating range for the heat pumps (e.g. between-10° C. and +10° C.), the inside of the greenhouse is heated via the set of radiators fed by the second, medium-temperature energy stack; or
   iii) when the temperature when the outside temperature is measured is equal to or higher than a useful temperature of the greenhouse, the inside of the greenhouse is cooled by means of said set of radiators powered by the third low-temperature energy stack; and
      when the measured outside temperature Tₑₓₜ approaches the minimum threshold for adequate operation of the heat pump(s), the method then comprises:
d) a step in which heat is exchanged from the first to the second energy stack to heat the second fluid in the second energy stack.

The minimum operating threshold and the minimum operating range of the heat pump(s) depend in particular on the heat pump power and the technology. These operating parameters may therefore change over time and would not be a limiting element of the present invention.

To date, a minimum operating threshold temperature is around −12/−10° C.

According to a preferred mode, the method can also include a step in which air from outside the greenhouse is injected at greenhouse floor level, at greenhouse ridge level, or at both levels in order to control greenhouse hydrometry.

According to a preferred mode, the method can also include a step in which heat is transferred, at the rate of day and night cycles, from the low-temperature stack (300) to the medium-temperature stack (200) to maintain the temperature of the second fluid in the medium-temperature stack using the heat extracted from the cold stack (300). For example, as mentioned above, a water-to-water heat pump can be used for this heat exchange.

According to another aspect, the present invention relates to a method of energy and hydrometric control of a horticultural greenhouse which comprises the following steps:
a) the outside temperature of the greenhouse is measured, for example with the outside sensor (620);
b) i) when the outside temperature measured is less than about −10° C., the inside of the greenhouse is heated by means of a set of heating pipes (130) installed in the greenhouse and supplied with a first fluid (F1) from a first high-temperature energy stack (100) comprising a first tank (110) designed to contain a first volume of the first fluid (F1) previously heated to a first temperature of at least 60° C. by means of one or more boilers (120);
   ii) when the outside temperature measured is between approximately −10° C. and +10° C., the inside of the greenhouse is heated by means of a set of radiators (230) installed in the greenhouse and supplied with a second fluid (F2) from a second medium-temperature energy stack (200) comprising a second tank (210) designed to contain a second volume of the second fluid (F2) previously heated to a second temperature of between approximately 40° C. and 60° C., using one or more electrically powered heat pumps programmed to produce heat; or
   iii) when the measured outside temperature is equal to or greater than +10° C., the interior of the greenhouse is cooled by means of said set of radiators (230) installed in the greenhouse and supplied with the second fluid (F2) from a third low-temperature energy stack (300) comprising a third reservoir (310) designed to contain a third volume of the second fluid (F2) previously cooled to a third temperature of between about 2 and 10° C. by means of the one or more electrically-powered heat pumps programmed to produce cold; and
c) air from outside the greenhouse is injected at greenhouse floor level (410), at greenhouse ridge level (420), or at both levels to control greenhouse hydrometry.

When the outside temperature approaches a limit temperature for proper operation of the heat pump(s), the method includes:
d) a step in which heat is exchanged from the first to the second energy stack to heat the second fluid in the second energy stack.

According to a preferred mode, the method further comprises a step in which ice and/or snow present in the vicinity of the greenhouse is melted via a set of means, such as pipes (140), installed outside the greenhouse fluidically connected to the first stack (100). As already mentioned, these pipes (140) can be made of cast iron, steel (with or without fins), or any other suitable conductive material.

According to a preferred mode, the method also includes a step in which the hydrometry of the greenhouse is controlled via adiabatic and controllable greenhouse cooling means installed in the greenhouse, such as misters (500).

According to a preferred method, the method also includes a step in which the temperature inside the greenhouse, the temperature outside the greenhouse and the humidity level inside the greenhouse are measured. As mentioned above, these measurements are preferably made using probes or sensors installed inside the greenhouse (temperature (610) or hydrometry (630)) and outside the greenhouse (temperature (620)).

According to a preferred mode, the method also includes a step during which the operation of the various greenhouse control elements is programmed and controlled by a computer or intelligent device equipped with computer software and connected to said elements via a wired or wireless network such as Wifi or Bluetooth™. The various greenhouse control elements include the hydrological station (600) equipped with temperature and humidity measurement probes (610, 620, 630), the boiler(s) (120), the heat pump(s) (220), mechanized and controllable fresh air supply means (400), and/or heat transfer between the first and second energy stacks (160), or between the second and third stacks (not illustrated).

According to another aspect, the present invention relates to a computer program comprising instructions suitable for implementing each of the steps of the methods described herein the method, when the program is executed on a computer.

FIGS. 2 and 3 illustrate a greenhouse, and in particular the mechanical air supply means (400) as discussed above, and the circulation of air in the greenhouse via vertical (VAF) or horizontal (HAF) fans. The metric data shown in FIGS. 2 and 3 are indicative only and by no means limitative of the invention. The use of fans is also described in part below. In particular, FIG. 2 illustrates air supply from the ridge of the greenhouse (410), and FIG. 3 shows air supply from the floor or bottom of the greenhouse (420). Both systems can be present. In FIG. 3, reference 450 represents ground level, and reference 460 represents underground pipes.

FIG. 2 also shows the possibility of having structural elements high up or suspended in the greenhouse, for example a table (430) in the germination zone (440).

The invention as described here provides several advantages. These advantages include the following:
A) The system described introduces a dissociation of the heating networks in order to maximize the potential of the heat pumps (220); while preserving the requirements for snowmelt and extreme cold through the combined use of boilers (120);
B) The system described uses three water tanks (110, 210, 310) of energy stacks or piles, at different temperatures, instead of a single tank or pile;
C) The system provides a thermal connection (160) between the high-temperature loop (100) and the medium-temperature loop (200), enabling a large amount of energy to be discharged when the heat pump network becomes ineffective (very low temperature);
D) The system allows the inclusion of a medium-temperature hot water loop (200) enabling the use of alternative energy sources (270), such as solar concentrators, wind, hydraulic and geothermal;
E) The system according to the invention makes it possible to combine a mechanized means of fresh air supply (400) with the distribution of heating providing a large quantity of CO₂ to the plants in the greenhouse;
F) The system according to the invention makes it possible to combine a mechanical and adiabatic cooling system (500) inside an elevated enclosure (see FIGS. 2 and 3). This combination transforms the greenhouse into a mixing chamber where conditions are optimal, and energy gradients form naturally.

Benefits of the invention:
1) Optimizes the use of heat pumps (220);
2) Reduces GHGs as 80% of energy comes from heat pumps (200) (annual basis);
3) Allows use of high-efficiency (220) heat pumps for heating and cooling;
4) Allows the use of primary energy loops (e.g. glycol), enabling heat pumps (220) to operate independently, in blocks or in cascade, in all regions of the world.
5) Allows the integration of solar concentrators or any other energy source (270) via an interface in the glycol loop. Networking and energy transport in the energy loops can be configured using high-efficiency fluids (F2).
6) Allows air in the cultivation area to be dehumidified at any time via the network connected to the low-temperature energy stack (300) at approx. 3° C.;
7) Dehumidification via the low-temperature energy stack (300) at approx. 3° C., significantly improves the efficiency of the misting systems (500).
8) Extremely flexible climate management;
9) Ground-level air supply (410) increases CO₂ density and productivity at lower cost, since CO₂ is heavier than air; and
10) Enables easy expansion of the energy network via its glycol network. For example, the parallel configuration of heat pumps requires only one connection to the network in the event of an addition.

Field of application and scope:
The present invention applies primarily to various greenhouse crops. The variety and/or type of plant has no effect on the patent, and the patent remains applicable in all respects.
The present invention applies regardless of the shape of the greenhouse, its size, height, covering, etc.;
The various fluids used in alternative energy loops are primarily intended to be, but not limited to, steam, oil and glycol.
The various fluids used in the energy loops coming from the heat pumps (220) are mainly intended to be glycol or water without limitation.
Boilers (120) are potentially powered by, but not limited to, natural gas, propane or electricity.
The present invention applies irrespective of the size of the boilers (120), their source of supply, their type;
The present invention applies regardless of the type of heat pumps (220) used (air-to-air/air-to-water/water-to-water);
The temperatures quoted (90° C., 60° C., 45° C., 3° C.) will potentially be optimal at a given time of year. Any different adjustment or calibration of these temperatures has no effect on patent protection;
The shape, size and type of power stacks have no effect on patent protection;
The use of various sources of electrical energy (270) such as grid (280), wind or solar power are only indicative, the use of any other sources of energy has no effect on the protection conferred by the patent;
Temperature ranges may differ from region to region and/or country to country. The variation in these energy utilization ranges has no effect on patent protection;
The use or non-use of natural ventilation mechanisms (400) has no effect on the patent, and the patent remains applicable in all respects; and
The size of the mechanical elements, type, flow rate, voltage etc., which supply the greenhouse with air and CO₂ have no effect on the patent, and the patent remains in full force and effect.

### Management Logic Minimizing Energy(S) and CO₂Costs

Optimal solution=Function minimizing the following 2 variables: Energy costs & CO₂ emissions.

Initial assomptions:
1) Temperature range for optimum heat pump operation maximizing COP is −10° C.<Tₑₓₜ<45° C.
2) Heat pump sizing is equal to or greater than 35% of peak heating capacity and 120% of peak cooling capacity.
3) Reserves (stacks or piles) are sized according to cumulative out-of-range requirements, i.e. periods of extreme cold or heatwave.
4) The high-temperature circuit is supplied by third-party energy.

These assumptions may vary from one site to another, from one crop to another and/or according to the technologies chosen (heat pumps).

### Primary Management Instructions:

A) If Tₑₓₜ (outdoor temperature) is within the optimum operating range (e.g. Tₑₓₜ≥10° C.), heat pumps are preferred;
B) If Tₑₓₜ is below the minimum operating threshold for heat pumps (e.g. Tₑₓₜ≤10° C.), the energy stored in the 2 piles (100, 200) is used first;
C) If the cold period is prolonged and/or the 45° C. battery (200) becomes weak, energy is transferred between the batteries;
D) Over the course of the seasons and on a regular basis (e.g. bi-weekly), heat pump capacity setpoints can be reviewed to determine what percentage of the available energy will be used for heating and what percentage will be used for cooling. These calculations preferably take into account the following elements: energy requirements according to weather forecasts and calculated degree-days, battery condition, daily operating energy input (e.g. lamps, motor power), etc.
E) If no fossil energy is required, CO₂ can be added to the greenhouse via the adduction system;
F) Reduce (if possible) the temperature of the high-temperature network to 45 or 60° C. in summer;
G) We can always maximize the use of the central battery (45° C.).

### Daily Setpoints:

During winter (daytime) and normal periods:
a) The greenhouse can be used as a conventional greenhouse;
b) Maximize the use of natural ventilation (very low energy consumption);
c) The 45° C. and 3° C. (200, 300) circuits can be used according to current needs;
d) Pile or stack 90° C. (100) can be used in maintenance mode;
e) VAF and HAF can be used at normal speed;

During heatwaves and/or when the enthalpy of the outside air is higher than that measured at the ridge of the greenhouse:
a) You can switch to semi- or totally closed mode (these two modes minimize gas exchanges with the outside, or even avoid them for a certain period of time);
b) You can switch to stratified climate management mode;
c) You can activate air supply in minimal mode and maintain a slight positive pressure;
d) HAF and VAF speeds can be used at the minimum threshold;
e) You can dehumidify with the 3° C. and 45° C. circuits and rehumidify with the misting system (500) when necessary, i.e. to ensure that the air changes from cool and dry at ground level to warm and humid at ridge level. In such cases, and on certain occasions, it may be necessary to use an overhead misting system. Warm, dry air will tend to de-stratify. Complete probes can be installed at more than one level, so that air characteristics can be monitored in real time. The mechanical system located on the ground (410) can remove grams of H₂O, while the aerial misters (500) add some. These two networks are not in competition with each other; they are two distinct tools for achieving the natural phase changes of air and water at lower cost.
f) The Pile 90° C. is used in maintenance mode;

In winter, at night and/or when 80% of energy is used for heating:
a) We can switch to stratification mode, as in this case it's preferable to mix the air well to retain maximum heat in the cultivation zone and reduce the risk of condensation;
b) HAF and VAF fans speeds can be used in maximum mode;
c) air supply can be activated in minimum mode and a slight positive pressure maintained. This option is important in very cold and windy weather. As during heatwaves, it is important to preserve the integrity of the building envelope by counteracting unwanted infiltration due to pressure differences;
d) Stacks and energy can be managed according to the primary instructions.

Although described in terms of one or more preferred embodiments, it should be understood that the present invention can be used, employed and/or embodied in a multitude of other forms. Thus, the following claims are to be interpreted to include these various forms while remaining outside the limits set by the prior art.

1. A system for energy and hydrometric control of a horticultural greenhouse, comprising:
a set of heating pipes installed in the greenhouse to heat the greenhouse interior;
a set of radiators installed in the greenhouse to heat or cool the greenhouse interior;
one or more boilers;
one or more electrically powered heat pumps;
a first tank containing a first fluid (F1) previously heated to a first temperature Te of between about 45 and 90° C. using:
said one or more boilers,
heat exchange with a distribution loop of a second fluid (F2) previously heated to a second temperature by means of said one or more electrically powered heat pumps programmed to produce heat, or
the combined action of the one or more boilers and heat exchange with the distribution loop;
the distribution loop forming part of the control system, and the first tank being fluidly connected to the set of heating pipes installed in the greenhouse to heat the greenhouse interior;
another reservoir containing a third fluid (F3) previously cooled to a temperature of between approximately 2 and 10° C. using the electrically powered heat pump(s) programmed to produce cold;
the distribution loop and the other reservoir being fluidly connected to the set of radiators installed in the greenhouse to heat or cool the greenhouse interior; and
a hydrological station comprising at least one first probe for measuring the temperature inside the greenhouse, at least one second probe for measuring the temperature outside the greenhouse and at least one probe for measuring the humidity level inside the greenhouse.

2. The system according to claim 1, wherein the distribution loop is configured to heat the second fluid to temperature Te when the temperature outside the greenhouse is sufficiently high to use only the heat pump(s) to heat the first fluid in the first tank and the second fluid (F2) in the distribution loop.

3. The system according to claim 1, further comprising a second tank designed to contain the second fluid previously heated using the heat pump(s), said heat exchange then taking place between the first and second tanks, the second tank being fluidly connected to the set of radiators installed in the greenhouse to heat the greenhouse interior.

4. The system according to claim 1, further comprising mechanized and controllable means for supplying air from outside the greenhouse to inject air at greenhouse floor level, at greenhouse ridge level, or at both levels in order to control greenhouse hydrometry.

5. The system according to claim 1, wherein the first fluid (F1) comprises water and the second fluid (F2) comprises a high efficiency energy transport fluid such as glycol, oil or steam.

6. The system according to claim 1, wherein the first reservoir is also fluidly connected to a set of means, such as pipes, installed outside the greenhouse for melting ice and/or snow present in the vicinity of the greenhouse.

7. The system according to claim 1, wherein:
the boiler or boilers are powered by fossil, electric or geothermal energy, or a mixture of these energies; and
the heat pump(s) is/are supplied with electricity generated by alternative energies selected from hydraulic, wind, solar, geothermal, biofuel and mixtures thereof.

8. The system according to claim 1, further comprising adiabatic and controllable greenhouse cooling means installed in the greenhouse, such as misters, in order to control the hydrometry of the greenhouse.

9. The system according to claim 1, further comprising a computer or an intelligent device equipped with computer software and connected to the various greenhouse control elements via a wired or wireless network in order to program and control the operation of the hydrological station and its sensors, the boiler(s), the thermal pump(s), the mechanized and controllable means of fresh air supply, and/or the heat transfer.

10. Method for energy and hydrometric control of a horticultural greenhouse implementing the system as claimed in claim 1, comprising the following steps:
a) the outside temperature of the greenhouse (Tₑₓₜ) is measured;
b) i) when the outside temperature Tₑₓₜ measured is below a threshold temperature (for example: T₍ₑₓₜ₎≤10° C.), the inside of the greenhouse is heated via heating pipes supplied with the first fluid;
ii) when the measured outside temperature Tₑₓₜ is above the threshold temperature (e.g. Tₑₓₜ>10° C.), the inside of the greenhouse is heated via the set of radiators supplied by the second fluid; or
iii) when the measured outside temperature Tₑₓₜ is equal to or greater than a useful temperature of the greenhouse, the inside of the greenhouse is cooled using said set of radiators fed by the third fluid.

11. The method according to claim 10, further comprising a step in which air from outside the greenhouse is injected at greenhouse floor level, at greenhouse ridge level, or at both levels in order to control greenhouse hydrometry.

12. A system for energy and hydrometric control of a horticultural greenhouse, comprising:
a set of heating pipes installed in the greenhouse to heat the greenhouse interior;
a set of radiators installed in the greenhouse to heat or cool the greenhouse interior;
one or more boilers;
one or more electrically powered heat pumps;
a first high-temperature energy stack comprising a first reservoir containing a first volume of a first fluid previously heated to a first temperature of at least 60° C. using the one or more boilers, the first stack being fluidly connected to said set of heating pipes installed in the greenhouse to heat the interior of the greenhouse;
a second medium-temperature energy stack comprising a second reservoir containing a second volume of a second fluid previously heated to a second temperature of between about 40 and 60° C. by means of the one or more electrically powered heat pumps programmed to produce heat, the second stack being fluidly connected to said set of radiators installed in the greenhouse to heat the interior of the greenhouse;
a third low-temperature energy stack comprising a third reservoir designed to contain a third volume of said second fluid previously cooled to a third temperature of between about 2 and 10° C. using the electrically powered heat pump(s) programmed to produce cold, the third stack being fluidly connected to said set of radiators installed in the greenhouse to cool the interior of the greenhouse; and
a hydrological station comprising at least one first probe for measuring the temperature inside the greenhouse, at least one second probe for measuring the temperature outside the greenhouse and at least one probe for measuring the humidity level inside the greenhouse;
and wherein:
the first and second energy stacks are thermally interconnected to enable heat exchange from the first to the second stack when the outside temperature is too low to use the heat pump(s) to heat the second fluid in the second energy stack.

13. The system according to claim 12, further comprising mechanized and controllable means for supplying air from outside the greenhouse to inject air at greenhouse floor level, greenhouse ridge level, or both levels in order to control greenhouse hydrometry.

14. The system according to claim 12, wherein the first fluid comprises water and the second fluid comprises a high efficiency energy transport fluid such as glycol, oil or steam.

15. The system according to claim 12, wherein the first stack is also fluidly connected to a set of means, such as pipes, installed outside the greenhouse for melting ice and/or snow present in the vicinity of the greenhouse.

16. The system according to claim 12, wherein:
the boiler or boilers are powered by fossil, electric or geothermal energy, or a mixture of these energies; and
the heat pump(s) is/are supplied with electricity generated by alternative energies selected from hydraulic, wind, solar, geothermal, biofuel and mixtures thereof.

17. The system according to claim 12, further comprising adiabatic and controllable greenhouse cooling means installed in the greenhouse, such as misters, in order to control the hydrometry of the greenhouse.

18. The system according to claim 12, further comprising a computer or intelligent device equipped with computer software and connected to the various greenhouse control elements via a wired or wireless network in order to program and control the operation of the hydrological station and its probes, the boiler(s), the thermal pump(s), the mechanized and controllable means of supplying fresh air, and/or heat transfer between the first and second energy stacks.

19. Method for energy and hydrometric control of a horticultural greenhouse implementing the system as claimed in claim 12, comprising the following steps:
a) the outside temperature of the greenhouse (Tₑₓₜ) is measured;
b) i) when the measured outside temperature Tₑₓₜ is below a minimum threshold for heat pump operation (for example: T₍ₑₓₜ₎≤10° C.), the inside of the greenhouse is heated via the heating pipes supplied by the first high-temperature energy stack;
ii) when the measured outdoor temperature Tₑₓₜ is within an optimum operating range for the heat pumps (e.g. between −10° C. and +10° C.), the interior of the greenhouse is heated via the set of radiators fed by the second medium-temperature energy stack; or
iii) when the measured outside temperature is equal to or greater than a useful temperature of the greenhouse, the inside of the greenhouse is cooled using the said set of radiators powered by the third low-temperature energy stack; and
when the outside temperature approaches the minimum heat pump operating threshold, the method further comprises:
c) a step in which heat is exchanged from the first energy stack to the second energy stack to heat the second fluid in the second energy stack.

20. The method according to claim 19, further comprising a step in which air from outside the greenhouse is injected at the greenhouse floor level, at the greenhouse ridge level, or at both levels in order to control the hydrometry of the greenhouse.
